(19) United States
(12) Patent Application Publication
(10) Pub. No.: US 2022/0093907 A1
(43) Pub. Date: Mar. 24, 2022

(54) SECONDARY BATTERY

(71) Applicant: Murata Manufacturing Co., Ltd., Nagaokakyo-shi (JP)

(72) Inventor: Masato Fujioka, Nagaokakyo-shi (JP)

(21) Appl. No.: 17/544,036

(22) Filed: Dec. 7, 2021

Related U.S. Application Data
(63) Continuation of application No. PCT/JP2020/031293, filed on Aug. 19, 2020.

(30) Foreign Application Priority Data
Aug. 30, 2019 (JP) 2019-158286

(51) Int. Cl. H01M 4/133; H01M 4/62; H01M 4/139; H01M 10/0587; H01M 50/533; H01M 10/0525

(52) U.S. Cl. CPC H01M 4/133; H01M 4/622; H01M 10/0525; H01M 10/0587; H01M 50/533; H01M 4/139

(57) ABSTRACT

A secondary battery including a positive electrode, a negative electrode, and a separator between the positive electrode and the negative electrode. In the secondary battery, at least one of the positive electrode and the negative electrode contains an electrode active material, a carbon nanotube, and a polymer dispersant, and in which the carbon nanotube has a basic site amount relatively larger than an acid site amount, and the polymer dispersant has an acidic functional group.

### CROSS REFERENCE TO RELATED APPLICATIONS

The present application is a continuation of International application No. PCT/JP2020/031293, filed Aug. 19, 2020, which claims priority to Japanese Patent Application No. 2019-158286, filed Aug. 30, 2019, the entire contents of each of which are incorporated herein by reference.

### FIELD OF THE INVENTION

The present invention relates to a secondary battery.

### BACKGROUND OF THE INVENTION

A secondary battery is a so-called storage battery and can therefore be repeatedly charged and discharged, and the secondary battery is used for various applications. For example, secondary batteries are used in mobile devices such as mobile phones, smartphones, and notebook computers.

A secondary battery generally has a structure in which an electrode assembly is housed in an exterior body. That is, in the secondary battery, the electrode assembly is housed in the exterior body serving as a case.

Patent Document 1: Japanese Patent Application Laid-Open No. 2004-281096

Patent Document 2: Japanese Patent Application Laid-Open No. 2016-193820

### SUMMARY OF THE INVENTION

The inventor of the present application has noticed that there is a problem to be overcome in the conventional secondary battery and has found a need to take measures therefor. Specifically, the inventor of the present application has found that there are following problems.

A secondary battery generally has a structure in which a positive electrode, a negative electrode, a separator disposed between the positive electrode and the negative electrode, and an electrolyte are enclosed in an exterior body.

In such a secondary battery, for the purpose of reducing the resistance of the electrode and improving the cycle characteristics, an electrode containing a carbon material such as carbon black as a conductive additive has been proposed (for example, Patent Documents 1 and 2). Patent Document 2 proposes an electrode using polyvinylpyrrolidone as a dispersant in order to improve dispersibility of carbon nanotubes in an electrode material.

A dispersant such as polyvinylpyrrolidone is unlikely to be adsorbed on the surface of carbon nanotubes having a particularly large amount of basic sites (hereinafter may be referred to as a “basic site amount”), and thus a large amount of the dispersant may be required to be added. Addition of a large amount of the dispersant may cause time-related degradation (such as degradation of cycle characteristics) of the electrode structure due to dissolution in the electrolytic solution.

On the other hand, when the amount of the dispersant added is a small amount, the dispersibility of carbon nanotubes in the electrode is poor, and there is a possibility that desired battery characteristics cannot be obtained. In addition, there is a possibility that a problem in a manufacturing process such as an increase in dispersion time occurs.

The present invention has been made in view of such problems. That is, a main object of the present invention is to provide a secondary battery that includes an electrode having a lower resistance and has more excellent cycle characteristics.

The present invention relates to a secondary battery including a positive electrode, a negative electrode, and a separator between the positive electrode and the negative electrode, in which at least one of the positive electrode and the negative electrode contains an electrode active material, a carbon nanotube, and a polymer dispersant, and where the carbon nanotube has an amount of basic sites relatively larger than an amount of acid sites (hereinafter may be referred to as an “acid site amount”), and the polymer dispersant has an acidic functional group (hereinafter may be referred to as an “acidic functional group”).

The secondary battery according to one embodiment of the present invention includes an electrode having a lower resistance and has more excellent cycle characteristics.

Specifically, in the secondary battery according to the embodiment of the present invention, at least one of the positive electrode and the negative electrode contains an electrode active material, carbon nanotubes, and a polymer dispersant. Here, the basic site amount is relatively larger than the acid site amount in the carbon nanotubes. The polymer dispersant has an acidic functional group (hereinafter may be referred to as an “acidic functional group”).

With the above-described configuration, the ability of the polymer dispersant to be adsorbed on the surface the carbon nanotubes is enhanced. Thereby, an electrode in which carbon nanotubes are well dispersed with a small amount of dispersant is obtained. Therefore, the resistance of the electrode is further reduced, and the cycle characteristics of the secondary battery is improved. In addition, it is also possible to improve the efficiency of the manufacturing process, such as shortening the dispersion time.

### BRIEF EXPLANATION OF THE DRAWINGS

FIGS. 1A and 1B are schematic sectional views of electrode assemblies (FIG. 1A shows an electrode assembly of a non-wound planar stacked battery, and FIG. 1B shows an electrode assembly of a wound battery).

FIG. 2 is a schematic perspective view for explaining each constituent member of an electrode assembly capable of constituting a secondary battery according to an embodiment of the present invention.

FIGS. 3A and 3B are schematic perspective views for explaining a method of assembling electrodes constituting the secondary battery according to the embodiment of the present invention.

### DETAILED DESCRIPTION OF THE INVENTION

A secondary battery according to an embodiment of the present invention will be described below in more detail. Although the description will be made with reference to the drawings as necessary, various elements in the drawings are merely schematically illustrated as an example to facilitate understanding of the present invention, and appearance, dimensional ratios, and the like may be different from actual ones.

The “thickness direction” described directly or indirectly in the present specification is based on a direction (or a stacking direction) in which electrode materials constituting the secondary battery are stacked (for example, in the thickness direction of the planar stacked electrode assembly and the wound electrode assembly). For example, in the case of a “secondary battery having a thickness in a plate shape” such as a flat battery, the “thickness direction” corresponds to the plate thickness direction of the secondary battery. In other words, the “thickness direction” is based on a direction parallel to a surface having the smallest dimension among surfaces constituting the secondary battery.

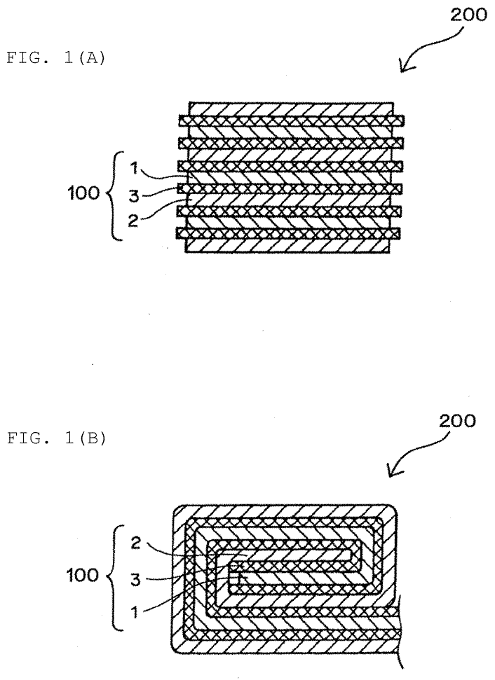

The “sectional view” in the present specification is based on a form (in other words, a form in the case of being cut along a plane substantially parallel to the thickness direction) in a case where an object (such as a planar stacked electrode assembly and a wound electrode assembly) is grasped along a direction substantially perpendicular to the thickness direction. In short, the “sectional view” is based on the form of the section of the object shown in FIG. 1 and the like. That is, the “sectional view” corresponds to a virtual section in which the planar stacked state and the wound state can be grasped (see FIGS. 1A and 1B).

As used herein, “basic” and “acidic” refer to a Lewis base and a Lewis acid, respectively. Specifically, a substance (electron-pair donor) capable of donating an unshared electron pair is a Lewis base, and a substance (electron-pair acceptor) capable of accepting an unshared electron pair is a Lewis acid. That is, the “basic functional group” and the “acidic functional group” used in the present specification refer to a functional group of a Lewis base and a functional group of a Lewis acid, respectively.

The basic functional group is not particularly limited, and examples thereof include a hydroxy group and an amino group. The acidic functional group is not particularly limited, and examples thereof include a carboxy group, a carbonyl group, a sulfonyl group, and a sulfate ester group.

### Basic Configuration of Secondary Battery According to Embodiment of Present Invention

The present invention provides a secondary battery. In the present specification, the term “secondary battery” refers to a battery that can be repeatedly charged and discharged. The “secondary battery” is not excessively limited by its name, and can include, for example, an electrochemical device such as a “power storage device”.

The secondary battery according to the embodiment of the present invention includes a positive electrode, a negative electrode, and a separator. Specifically, the secondary battery according to the embodiment of the present invention includes an electrode assembly in which at least one or more electrode constituent units including a positive electrode, a negative electrode, and a separator are stacked. The separator can be disposed between the positive electrode and the negative electrode.

FIGS. 1A and 1B illustrate an electrode assembly 200. As illustrated, a positive electrode 1 and a negative electrode 2 are stacked with a separator 3 interposed therebetween to form an electrode constituent unit 100. At least one or more of such electrode constituent units 100 may be stacked in a flat plate shape to constitute the electrode assembly 200 (see FIG. 1A). Alternatively, the electrode assembly 200 may be constituted by winding the electrode constituent unit 100 (see FIG. 1B). In the secondary battery, it is preferable that such an electrode assembly is enclosed in an exterior body together with an electrolyte (such as a nonaqueous electrolyte).

### Electrode

The positive electrode may be constituted of at least a positive electrode material layer and a positive electrode current collector (such as a positive electrode current collector in a layer form). In the positive electrode, a positive electrode material layer may be provided on at least one surface of the positive electrode current collector, and the positive electrode material layer may contain a positive electrode active material as an electrode active material. For example, in each of the plurality of positive electrodes in the electrode assembly, positive electrode material layers may be provided on both surfaces of the positive electrode current collector. Alternatively, the positive electrode material layer may be provided only on one surface of the positive electrode current collector. From the viewpoint of further increasing the capacity of the secondary battery, the positive electrode is preferably provided with positive electrode material layers on both surfaces of the positive electrode current collector. The positive electrode current collector may have a foil form. That is, the positive electrode current collector may be formed of a metal foil. In the positive electrode used in the wound electrode assembly, the positive electrode material layer may not be provided on part of the positive electrode current collector.

The negative electrode may be constituted of at least a negative electrode material layer and a negative electrode current collector (such as a negative electrode current collector in a layer form). In the negative electrode, a negative electrode material layer may be provided on at least one surface of the negative electrode current collector, and the negative electrode material layer may contain a negative electrode active material as an electrode active material. For example, in each of the plurality of negative electrodes in the electrode assembly, negative electrode material layers may be provided on both surfaces of the negative electrode current collector. Alternatively, the negative electrode material layer may be provided only on one surface of the negative electrode current collector. From the viewpoint of further increasing the capacity of the secondary battery, the negative electrode is preferably provided with negative electrode material layers on both surfaces of the negative electrode current collector. The negative electrode current collector may have a foil form. That is, the negative electrode current collector may be formed of a metal foil. In the negative electrode used in the wound electrode assembly, the negative electrode material layer may not be provided on part of the negative electrode current collector.

The electrode active materials that can be contained in the positive electrode and the negative electrode, that is, the positive electrode active material and the negative electrode active material, are substances directly involved in the transfer of electrons in the secondary battery and are main substances of the positive electrode and the negative electrode that are responsible for charging and discharging, that is, a cell reaction. More specifically, ions can be brought into the electrolyte due to the “positive electrode active material that can be contained in the positive electrode material layer” and the “negative electrode active material that can be contained in the negative electrode material layer”. Such ions move between the positive electrode and the negative electrode to transfer electrons, and charging and discharging can be performed.

In particular, the positive electrode material layer and the negative electrode material layer may be layers constructed to occlude and release lithium ions. For example, the secondary battery may be a nonaqueous electrolyte secondary battery in which lithium ions move between the positive electrode and the negative electrode through the nonaqueous electrolyte to charge and discharge the battery. When lithium ions are involved in charging and discharging, the secondary battery according to the embodiment of the present invention corresponds to a so-called lithium ion battery. In the lithium ion battery, each of the positive electrode and the negative electrode has a layer capable of occluding and releasing lithium ions.

As the positive electrode active material of the positive electrode material layer is made of, for example, a granular material, a binder (also referred to as a “positive electrode active material binding agent” or simply a “positive electrode binding agent” or “binding material”) may be contained in the positive electrode material layer for more sufficient contact between particles and shape retention. Furthermore, a conductive additive for facilitating the transfer of electrons promoting the cell reaction and, if necessary, a dispersant for the conductive additive may be contained in the positive electrode material layer.

Similarly, as the negative electrode active material of the negative electrode material layer is made of, for example, a granular material, a binder (also referred to as a “negative electrode active material binding agent” or simply a “negative electrode binding agent” or “binding material”) may be contained in the negative electrode material layer for more sufficient contact between particles and shape retention, and a conductive additive for facilitating the transfer of electrons promoting the cell reaction and, if necessary, a dispersant for the conductive additive may be contained in the negative electrode material layer.

As described above, since a plurality of components are contained, the positive electrode material layer and the negative electrode material layer can also be referred to as a “positive electrode mixture layer” and a “negative electrode mixture layer”, respectively.

The positive electrode active material may be a material that contributes to occlusion and release of lithium ions. From such a viewpoint, the positive electrode active material may be, for example, a lithium-containing composite oxide. More specifically, the positive electrode active material may be a lithium transition metal composite oxide containing lithium and at least one transition metal selected from the group consisting of cobalt, nickel, manganese, and iron. That is, in the positive electrode material layer of the secondary battery according to the present embodiment, such a lithium transition metal composite oxide may be contained as the positive electrode active material.

For example, the positive electrode active material may be lithium cobaltate, lithium nickelate, lithium manganate, lithium iron phosphate, or a material obtained by replacing a part of these transition metals with another metal. Such a positive electrode active material may be contained as a single species, but two or more species may be contained in combination. In a preferred mode, the positive electrode active material that can be contained in the positive electrode material layer is lithium cobaltate.

The binder that can be contained in the positive electrode material layer is not particularly limited, and examples thereof include at least one selected from the group consisting of polyvinylidene fluoride, a vinylidene fluoride-hexafluoropropylene copolymer, a vinylidene fluoride-tetrafluoroethylene copolymer, and polytetrafluoroethylene. In an illustrative mode, the binder of the positive electrode material layer is polyvinylidene fluoride.

The conductive additive that can be contained in the positive electrode material layer is not particularly limited, and examples thereof include at least one selected from carbon blacks such as thermal black, furnace black, channel black, ketjen black, and acetylene black, carbon fibers such as graphite, carbon nanotubes, and vapor grown carbon fiber, powders of metals such as copper, nickel, aluminum, and silver, and polyphenylene derivatives. In an illustrative mode, the conductive additive of the positive electrode material layer is carbon nanotubes.

For example, carbon-containing materials (or carbon materials) such as carbon black, graphite, and carbon nanotubes may be surface-treated to increase affinity with an active material or the like. More specifically, the basic site amount and the acid site amount of the carbon material may be adjusted according to the configuration of the active material and the dispersant described later. The surface treatment of the carbon material may be performed by a chemical modification method and/or a physical modification method.

As an example of the surface treatment described above, the carbon material is first subjected to a strong acid treatment to introduce an acidic functional group (such as a carboxy group) to the surface, and then the carbon material is allowed to react with an alkyl amine, an alkyl alcohol, or the like to be chemically modified.

When the positive electrode material layer contains a carbon material such as carbon black and carbon nanotubes as the conductive additive, it is preferable that a dispersant for the conductive additive be contained. The dispersant is not particularly limited, and a known dispersant such as an acidic dispersant, a basic dispersant, an amphoteric dispersant, and a nonpolar dispersant may be used.

The acidic dispersant is not particularly limited, and examples thereof include at least one (including those acids, metal salts of those acids, and the like) selected from an alkylbenzenesulfonic acid, dodecylphenyl ether sulfonic acid, and polycarboxylic acid.

The basic dispersant is not particularly limited, and examples thereof include at least one selected from a quaternary alkylammonium salt, an alkylpyridinium salt, and an alkylamine salt.

The amphoteric dispersant is not particularly limited, and examples thereof include at least one selected from an alkylbetaine-based surfactant, a sulfobetaine-based surfactant, and an amine oxide-based surfactant.

The nonpolar dispersant is not particularly limited, and examples thereof include at least one selected from a cellulose derivative, polyvinyl alcohol, polyvinyl butyral, and polyvinylpyrrolidone.

The thickness dimension of the positive electrode material layer is not particularly limited but may be 1 μm to 100 μm, and is, for example, 5 μm to 20 μm. The thickness dimension of the positive electrode material layer is the thickness inside the secondary battery, and an average value of measured values at 10 arbitrary points can be adopted.

The negative electrode active material may be a material that contributes to occlusion and release of lithium ions. From such a viewpoint, the negative electrode active material may be, for example, any of various carbon materials, oxides, lithium alloys, and the like.

Examples of various carbon materials for the negative electrode active material include graphite (such as natural graphite, artificial graphite, and/or flake graphite), hard carbon, soft carbon, and/or diamond-like carbon. In particular, graphite is preferable in that it has high electron conductivity and, for example, excellent adhesion to a negative electrode current collector.

Examples of the oxide for the negative electrode active material include at least one selected from the group consisting of silicon oxide, tin oxide, indium oxide, zinc oxide, and lithium oxide. The lithium alloy for the negative electrode active material is only required to be an alloy containing lithium and a metal that can be alloyed with lithium, and is, for example, a binary, ternary, or higher alloy of lithium and a metal such as Al, Si, Pb, Sn, In, Bi, Ag, Ba, Ca, Hg, Pd, Pt, Te, Zn, and La.

The oxide as described above may be amorphous as its structural form. This is because deterioration due to nonuniformity such as grain boundaries and defects is less likely to occur. In an illustrative mode, the negative electrode active material of the negative electrode material layer is graphite, for example, artificial graphite and/or flake graphite.

The binder that can be contained in the negative electrode material layer is not particularly limited, and examples thereof include at least one selected from the group consisting of styrene-butadiene rubber, polyacrylic acid, polyvinylidene fluoride, a polyimide-based resin, and a polyamide-imide-based resin. In an illustrative mode, the binder contained in the negative electrode material layer is styrene-butadiene rubber.

The conductive additive that can be contained in the negative electrode material layer is not particularly limited, and examples thereof include at least one selected from carbon blacks such as thermal black, furnace black, channel black, ketjen black, and acetylene black, carbon fibers such as graphite, carbon nanotubes, and vapor grown carbon fiber, powders of metals such as copper, nickel, aluminum, and silver, and polyphenylene derivatives. The negative electrode material layer may contain a component derived from a thickener component (such as carboxymethyl cellulose) used at the time of manufacturing the battery. In an illustrative mode, the conductive additive of the negative electrode material layer is carbon nanotubes.

The carbon-containing material that can be used for the negative electrode material layer, that is, the carbon material (such as carbon black, graphite, carbon nanotubes, and the like) may be surface-treated in order to enhance affinity with the active material and the like, similarly to the carbon material that can be used for the positive electrode material layer.

When the negative electrode material layer contains a carbon material such as carbon black, graphite, and carbon nanotubes as the conductive additive, it is preferable that a dispersant for the conductive additive be contained. As the dispersant, the same dispersant as that can be used for the positive electrode material layer may be contained.

The thickness dimension of the negative electrode material layer is not particularly limited but may be 1 μm to 100 μm, and is, for example, 10 μm to 70 μm. The thickness dimension of the negative electrode material layer is the thickness inside the secondary battery, and an average value of measured values at 10 arbitrary points can be adopted.

### Current Collector

The positive electrode current collector and the negative electrode current collector that can be used for the positive electrode and the negative electrode are members that contribute to collecting and supplying electrons generated in the active material due to the cell reaction. Such current collectors may be sheet-like metal members and may have a porous or perforated form. For example, the current collectors are metal foils, perforated metal, nets, expanded metal, or the like.

The positive electrode current collector that can be used for the positive electrode may be made of a metal foil containing at least one selected from the group consisting of aluminum, stainless steel, nickel, and the like, and is, for example, an aluminum foil.

On the other hand, the negative electrode current collector that can be used for the negative electrode may be made of a metal foil containing at least one selected from the group consisting of copper, stainless steel, nickel, and the like, and is, for example, a copper foil.

The thickness dimensions of the positive electrode current collector and the negative electrode current collector are not particularly limited but may be 1 μm to 100 μm, and are, for example, 10 μm to 70 μm. The thickness dimensions of the positive electrode current collector and the negative electrode current collector are the thicknesses inside the secondary battery, and an average value of measured values at 10 arbitrary points can be adopted for each dimension.

### Separator

For example, the separator is a member that can be provided from the viewpoint of preventing a short circuit due to contact between the positive electrode and the negative electrode, holding the electrolyte, and the like. In other words, it can be said that the separator is a member that allows ions to pass while preventing electronic contact between the positive electrode and the negative electrode. For example, the separator may be a porous or microporous insulating member and may have a film form due to its small thickness.

Although it is merely an example, a microporous film made of polyolefin may be used as the separator. In this regard, the microporous film that can be used as the separator may contain, for example, only polyethylene (PE) or only polypropylene (PP) as polyolefin.

Furthermore, the separator may be a laminate composed of a “microporous film made of PE” and a “microporous film made of PP”. The surface of the separator may be covered with an inorganic particle coating layer and/or an adhesive layer. The surface of the separator may have adhesiveness.

The thickness dimension of the separator is not particularly limited but may be 1 μm to 100 μm, and is, for example, 2 μm to 20 μm. The thickness dimension of the separator is the thickness inside the secondary battery (in particular, the thickness between the positive electrode and the negative electrode), and an average value of measured values at 10 arbitrary points can be adopted.

### Electrolyte

In the secondary battery according to the embodiment of the present invention, the electrode assembly including the positive electrode, the negative electrode, and the separator may be sealed in the exterior body together with the electrolyte. The electrolyte can assist movement of metal ions that can be released from the electrodes (positive electrode and negative electrode). The electrolyte may be a “non-aqueous” electrolyte, such as an organic electrolyte and an organic solvent, or may be an “aqueous” electrolyte containing water. The secondary battery according to the embodiment of the present invention may be, for example, a nonaqueous electrolyte secondary battery using an electrolyte containing a “nonaqueous” solvent and a solute as an electrolyte. The electrolyte may have a form such as a liquid form and a gel form (in the present specification, the “liquid” nonaqueous electrolyte is also referred to as a “nonaqueous electrolyte solution”).

As a specific solvent of the nonaqueous electrolyte, at least a carbonate may be contained. Such a carbonate may be a cyclic carbonate and/or a chain carbonate.

The cyclic carbonate is not particularly limited, and examples thereof include at least one selected from the group consisting of propylene carbonate (PC), ethylene carbonate (EC), butylene carbonate (BC), and vinylene carbonate (VC).

Examples of the chain carbonate include at least one selected from the group consisting of dimethyl carbonate (DMC), diethyl carbonate (DEC), ethyl methyl carbonate (EMC), and dipropyl carbonate (DPC).

In one illustrative mode of the present invention, a combination of a cyclic carbonate and a chain carbonate can be used as the nonaqueous electrolyte. For example, a mixture of ethylene carbonate and diethyl carbonate is used. A specific solute of the nonaqueous electrolyte may be, for example, a Li salt such as LiPF₆ and/or LiBF₄.

### Current Collector Tab

As a current collector tab, any current collector tab used in the field of secondary batteries can be used. The current collector tab may be made of a material capable of achieving electron movement. For example, the current collector tab may be constituted of a conductive material such as silver, gold, copper, iron, tin, platinum, aluminum, nickel, and/or stainless steel. The form of the current collector tab is not particularly limited, and may have, for example, a linear shape or a plate shape.

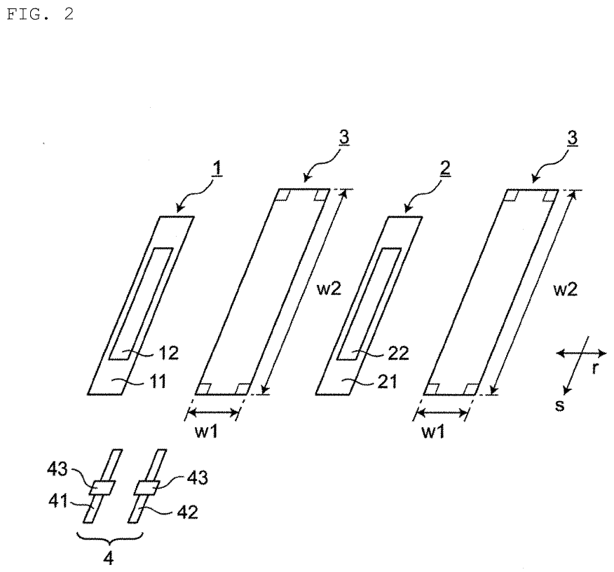

The current collector tab may be provided with an insulating material (for example, see an insulating material 43 in FIG. 2). With such a configuration, the elasticity of the current collector tab is improved by the elasticity of the insulating material, and the impact can be further absorbed. In addition, insulation between the current collector tab, the electrode assembly, and the exterior body can be further enhanced. Examples of the insulating material include insulating polymer materials such as polyesters (such as polyethylene terephthalate), polyimides, polyamides, polyamide-imides, and/or polyolefins (such as polyethylene and/or polypropylene).

The current collector tab may be provided integrally with the current collector that can be included in the electrode or may be provided on the current collector as a member different from the current collector of the electrode. In the positive electrode and the negative electrode, at least one positive electrode current collector tab and at least one negative electrode current collector tab may be provided, respectively. Alternatively, a plurality of current collector tabs may be provided for each of the positive electrode and the negative electrode.

### Exterior Body

The exterior body may be a hard case or a flexible case. In a case where the exterior body is a hard case, the exterior body may have, for example, a two-part configuration of a first exterior body and a second exterior body. The exterior body having the two-part configuration may include a main body and a lid. For example, in a case where the exterior body includes a main body and a lid, the main body and the lid may be sealed up after, for example, the electrode assembly, the electrolyte, the current collector tab, an electrode terminal if desired, and the like are housed. The method for sealing the exterior body is not particularly limited, and examples thereof include a laser irradiation method.

As a material constituting the main body and the lid of the exterior body, any material that can constitute a hard case type exterior body in the field of secondary batteries can be used. Such a material may be a conductive material in which electron transfer can be achieved or an insulating material in which electron transfer cannot be achieved.

The material of the exterior body is preferably a conductive material from the viewpoint of taking out the electrode. That is, the exterior body preferably includes two members of a positive electrode conductive portion and a negative electrode conductive portion. Here, the main body and the lid of the exterior body may constitute any one of the positive electrode conductive portion and the negative electrode conductive portion.

Examples of the conductive material of the exterior body include a metal material selected from the group consisting of silver, gold, copper, iron, tin, platinum, aluminum, nickel, and stainless steel. Examples of the insulating material include an insulating polymer material selected from the group consisting of polyesters (such as polyethylene terephthalate), polyimides, polyamides, polyamide-imides, and polyolefins (such as polyethylene and/or polypropylene).

From the viewpoint of the above-described conductivity, both the main body and the lid may be made of stainless steel. As defined in “JIS G 0203 Glossary of terms used in iron and steel”, stainless steel is alloy steel containing chromium or chromium and nickel, and generally refers to steel having a chromium content of about 10.5% or more of the whole. Examples of such stainless steel include martensitic stainless steel, ferritic stainless steel, austenitic stainless steel, austenitic ferritic stainless steel, and/or precipitation hardening stainless steel.

The dimensions of the main body and the lid of the exterior body can be determined mainly according to the dimensions of the electrode assembly. For example, the exterior body may have such dimensions that the movement of the electrode assembly in the exterior body is prevented when the electrode assembly is housed in the exterior body. By preventing the movement of the electrode assembly, it is possible to prevent the electrode assembly from being damaged due to an impact or the like and to improve the safety of the secondary battery.

The exterior body may be a flexible case such as a pouch made of a laminate film. The laminate film may have a configuration in which at least a metal layer (for example, aluminum or the like) and an adhesive layer (for example, polypropylene and/or polyethylene, etc.) are laminated and in which a protective layer (for example, nylon and/or polyamide, etc.) is additionally laminated.

The thickness dimension (that is, the wall thickness dimension) of the exterior body is not particularly limited but may be 10 μm to 200 μm, and is, for example, 50 μm to 100 μm. As the thickness dimension of the exterior body, an average value of measured values at 10 arbitrary positions can be adopted.

### Electrode Terminal

The secondary battery may be provided with an electrode terminal. The electrode terminal may be provided, for example, on at least one surface of the exterior body. For example, electrode terminals of the positive electrode and the negative electrode may be provided on different surfaces of the exterior body. From the viewpoint of taking out the electrodes, the electrode terminals of the positive electrode and the negative electrode are preferably provided on opposite surfaces of the exterior body.

The electrode terminal is preferably made of a material having high conductivity. The material of the electrode terminal is not particularly limited but may be at least one selected from the group consisting of silver, gold, copper, iron, tin, platinum, aluminum, nickel, and stainless steel.

In an example, the above-described current collector tabs of the positive electrode and the negative electrode may be electrically connected to the above-described electrode terminal and may be electrically led out to the outside of the secondary battery via the electrode terminal. In another example, the current collector tabs of the positive electrode and the negative electrode may be electrically connected to the exterior body and electrically led out to the outside of the secondary battery via the exterior body.

### Features of Secondary Battery According to Embodiment of Present Invention

The secondary battery according to the embodiment of the present invention is, for example, a battery including a positive electrode, a negative electrode, and a separator, specifically a secondary battery, and is characterized by configurations of the positive electrode and the negative electrode.

Specifically, in the secondary battery according to the embodiment of the present invention, at least one of the positive electrode and the negative electrode contains an electrode active material, carbon nanotubes, and a polymer dispersant. Here, the basic site amount is relatively larger than the acid site amount in the carbon nanotubes. In addition, the polymer dispersant has an acidic functional group. In the present invention, in the carbon nanotubes, an object of the present invention can be achieved if the “basic site amount” to be described in detail below is larger than the “acid site amount”, and therefore specific values and ranges of the basic site amount and the acid site amount are not particularly limited. For the same reason, in the present invention, the polymer dispersant may have an “acidic functional group” described in detail below.

With the above-described configuration, the ability of the polymer dispersant to be adsorbed on the surface of the carbon nanotubes is enhanced, and the dispersibility of the carbon nanotubes in the electrode active material can be improved with a small amount of dispersant. Therefore, it is possible to obtain an electrode having a lower resistance and a secondary battery having further improved cycle characteristics. In addition, since the dispersion time and the drying time can be shortened, the manufacturing process can be made more efficient.

The “basic site amount” (or the amount of basic sites) and the “acid site amount” (or the amount of acid sites) used in the present specification may be measured values obtained by the back titration method. The back titration method refers to a method in which a basic reagent (or an acidic reagent) whose concentration is known in advance is mixed with an object at a constant ratio, the object is sufficiently neutralized, then solid-liquid separation is performed with a centrifuge or the like, the supernatant is titrated with an acid (or a base), and the amount of the acid (or the amount of the base) of the object is obtained from the decreased amount of the basic reagent (or the amount of the acidic reagent).

The measurement method by the back titration method is illustrated below.

### Measurement Method by Back Titration Method

(1) Method for Determining Base Amount

In 30 mL of a 1/100 N acetic acid-toluene/ethanol (volume ratio: 48/52) solution, 2 g of an object (such as carbon nanotubes) that has been precisely weighed (sample amount) is placed and subjected to dispersion treatment with an ultrasonic cleaner (model 1510 J-MT manufactured by Branson Ultrasonics Corporation) for 1 hour. After standing for 24 hours, a part of the dispersion is subjected to solid-liquid separation at 25,000 rpm for 60 minutes using a centrifuge (model: CP-56G, manufactured by Hitachi, Ltd.). To 20 mL of a toluene/ethanol (volume ratio: 2/1) solution to which a phenolphthalein indicator has been added, 10 mL of the separated liquid portion is added, and then neutralization titration is performed with a 1/100 N potassium hydroxide-ethanol solution. Assuming that the titer at this time is X mL, the titer necessary for neutralizing 10 mL of the 1/100 N acetic acid-toluene/ethanol (volume ratio: 48/52) solution is B mL, and the sample amount is Sg, the base amount of the object is obtained by Formula (1) below.

$$Base amount ( μmol / g ) = 30 \times ( B - X ) / S \qquad Formula ( 1 )$$

In the present invention, the value and range of the base amount of the object obtained by Formula (1) above are not particularly limited.

(2) Method for Determining Acid Amount

In 30 mL of a 1/100 N n-butylamine-toluene/ethanol (volume ratio: 48/52) solution, 2 g of an object (such as carbon nanotubes) that has been precisely weighed (sample amount) is placed and subjected to dispersion treatment with an ultrasonic cleaner (model 1510 J-MT manufactured by Branson Ultrasonics Corporation) for 1 hour. After standing for 24 hours, a part of the dispersion is subjected to solid-liquid separation at 25,000 rpm for 60 minutes using a centrifuge (model: CP-56G, manufactured by Hitachi, Ltd.). To 20 mL of a toluene/ethanol (volume ratio: 2/1) solution to which a bromcresol green indicator has been added, 10 mL of the separated liquid portion is added, and then neutralization titration is performed with a 1/100 N hydrochloric acid-ethanol solution. Assuming that the titer at this time is X mL, the titer necessary for neutralizing 10 mL of the 1/100 N n-butylamine-toluene/ethanol (volume ratio: 48/52) solution is B mL, and the sample amount is Sg, the acid amount of the object is obtained by Formula (2) below.

$$Acid amount ( μmol / g ) = 30 \times ( B - X ) / S \qquad Formula ( 2 )$$

In the present invention, the value and range of the acid amount of the object obtained by Formula (2) above are not particularly limited.

In the embodiment, in an electrode including carbon nanotubes and a polymer dispersant, the electrode active material may be basic or have a basic functional group. When the electrode active material is basic or has a basic functional group, for example, an acidic functional group in the polymer dispersant and the electrode active material itself or the basic functional group in the electrode active material can interact with each other. Thereby, segregation of the carbon nanotubes on the electrode surface during manufacture (in particular, an electrode drying step) and/or use can be suppressed.

For example, in an electrode containing carbon nanotubes and a polymer dispersant, a weight ratio of the polymer dispersant to the carbon nanotubes may be 0.1 to 0.8. When the weight ratio is 0.1 or more, the volume resistivity of the electrode can be further reduced. When the weight ratio is 0.8 or less, the cycle characteristics of the secondary battery can be further improved. The weight ratio is preferably 0.1 to 0.5, and for example, 0.2 to 0.3.

The polymer dispersant may be composed of one type of dispersant or may contain a plurality of types of dispersants. In a case where the polymer dispersant contains a plurality of types of dispersants, the polymer dispersant may contain a plurality of dispersants having different compositions or may contain a plurality of dispersants having the same composition and different molecular weights.

The weight average molecular weight of the polymer that can be contained in the polymer dispersant may be 10,000 g/mol to 1,000,000 g/mol. When the molecular weight is 10,000 g/mol or more, the dispersion stability of carbon nanotubes in the electrode active material can be further enhanced. When the molecular weight is 1,000,000 g/mol or less, the adsorption capacity for carbon nanotubes can be enhanced, and dispersion uniformity can be further enhanced. The molecular weight is preferably 20,000 g/mol to 800,000 g/mol, and for example, 40,000 g/mol to 600,000 g/mol.

The weight average molecular weight of the polymer that can be contained in the polymer dispersant may refer to, for example, a value measured using gel permeation chromatography (GPC) (manufactured by Tosoh Corporation, product number: HLC-8120GPC).

In the embodiment, the polymer dispersant may include a relatively low molecular weight dispersant having a weight average molecular weight of less than 50,000 g/mol and a relatively high molecular weight dispersant having a weight average molecular weight of 50,000 g/mol or more in combination.

When the polymer dispersant contains the relatively low molecular weight dispersant as described above, the adsorption capacity for carbon nanotubes can be further enhanced, and the dispersion uniformity can be particularly enhanced. In addition, when the polymer dispersant contains the relatively high molecular weight dispersant as described above, the dispersion stability of carbon nanotubes in the electrode active material can be particularly enhanced.

When the polymer dispersant contains both the low molecular weight and high molecular weight dispersants, the dispersibility (that is, dispersion uniformity and dispersion stability) of carbon nanotubes can be particularly improved.

In the embodiment, the polymer dispersant preferably contains a polycarboxylic acid. Since the polycarboxylic acid has a structure to which a side chain having a new function can be introduced by a grafting reaction, a copolymerization reaction, or the like, the chemical structure and/or the molecular weight thereof can be adjusted. This makes it possible to impart desired functions such as higher adsorption capacity to carbon nanotubes and dispersion stability to the polymer dispersant.

Examples of the polycarboxylic acid include at least one selected from the group consisting of an acrylic acid polymer, a maleic acid polymer, an acrylic-maleic acid copolymer, an acrylic acid-acrylic acid ester copolymer, a styrene-acrylic acid copolymer, and a copolymer of maleic acid and styrene, vinyl acetate, and the like.

In the above-described mode, the polymer dispersant may contain a polycarboxylic acid salt in which a carboxy group in the polycarboxylic acid is, for example, in the form of a metal salt such as a sodium salt, a potassium salt, and a magnesium salt.

In a more preferred mode, the polymer dispersant contains an acrylic polymer containing an acrylic acid polymer, an acrylic acid copolymer, and/or a salt thereof (such as a sodium salt, a potassium salt, and a magnesium salt). Such an acrylic polymer is preferable because it has an acidic functional group such as a carboxy group. When the polymer dispersant contains an acrylic polymer, dispersibility of carbon nanotubes can be particularly enhanced. In particular, since the basic site amount is relatively larger than the acid site amount in the carbon nanotubes, the dispersibility of the carbon nanotubes can be dramatically enhanced by using a polymer dispersant having an acidic functional group, particularly a carboxy group, such as the above-described acrylic polymer, as the polymer dispersant. In addition, since a paste having a higher solid content can be formed, the manufacturing process can be made particularly efficient.

The acrylic acid polymer or the acrylic acid copolymer may be a polymer (or copolymer) of an unsaturated group-containing monomer having a functional group and/or an unsaturated group-containing monomer having no functional group. These polymers can be manufactured by a known method.

Specific examples of the unsaturated group-containing monomer having a functional group include an unsaturated monomer having a carboxy group such as (meth)acrylic acid, succinic acid 2-(meth)acryloyloxyethyl ester, phthalic acid 2-(meth)acryloyloxyethyl ester, hexahydrophthalic acid 2-(meth)acryloyloxyethyl, and an acrylic acid dimer and an unsaturated monomer having a tertiary amino group or a quaternary ammonium salt group such as dimethylaminoethyl (meth)acrylate, diethylaminoethyl (meth)acrylate, and quaternary products thereof. These may be used singly or in combination of two or more types.

Examples of the unsaturated group-containing monomer having no functional group include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, benzyl (meth)acrylate, phenyl (meth)acrylate, cyclohexyl (meth)acrylate, phenoxyethyl (meth)acrylate, phenoxymethyl (meth)acrylate, 2-ethylhexyl (meth)acrylate, isobornyl (meth)acrylate, tricyclodecane (meth)acrylate, tetrahydrofurfuryl (meth)acrylate, N-vinylpyrrolidone, styrene and derivatives thereof, α-methylstyrene, N-substituted maleimides such as N-cyclohexylmaleimide, N-phenylmaleimide, and N-benzylmaleimide, acrylonitrile, vinyl acetate, and macromonomers such as a polymethyl (meth)acrylate macromonomer, a polystyrene macromonomer, a poly(2-hydroxyethyl) (meth)acrylate macromonomer, a polyethylene glycol macromonomer, a polypropylene glycol macromonomer, and a polycaprolactone macromonomer. These may be used singly or in combination of two or more types.

In the embodiment, the carbon nanotubes may have a BET specific surface area of 100 m²/g or more. Here, the “BET specific surface area” may be a value that can be measured by a nitrogen adsorption method. However, the value and range of the BET specific surface area of the carbon nanotubes are not particularly limited as long as it is 100 m²/g or more.

In order to disperse the carbon nanotubes, it is necessary that the surface of the carbon nanotubes adsorb the functional group of the dispersant. Conventionally, when the BET specific surface area of the carbon nanotubes is 100 m²/g or more, more dispersant is required, and thus handling at the time of mixing may be difficult.

However, when the carbon nanotubes have a BET specific surface area of 100 m²/g or more as described above, the handleability at the time of mixing can be further improved by employing the configuration of the electrode according to the present invention. The carbon nanotubes preferably have a BET specific surface area of 150 m²/g to 3,000 m²/g, for example, 200 m²/g to 1,500 m²/g.

### Method for Manufacturing Secondary Battery According to Embodiment of Present Invention

The secondary battery according to the embodiment of the present invention can be manufactured, for example, by a manufacturing method including steps illustrated below. That is, a method for manufacturing the secondary battery according to the embodiment of the present invention includes, for example, a step (that is, a paste preparation step) of preparing an electrode material paste, a step (that is, an electrode forming step) of forming an electrode by applying the electrode material paste onto a current collector and drying the electrode material paste, a step (that is, an electrode assembling step) of obtaining an electrode assembly by stacking or winding a positive electrode, a negative electrode, and a separator, and a step (that is, a housing step) of injecting an electrolyte into an exterior body as necessary while housing the electrode assembly in the exterior body.

### Paste Preparation Step

A mode in which the positive electrode contains a positive electrode active material as an electrode active material and further contains carbon nanotubes and a polymer dispersant will be described below as an example.

The positive electrode material paste is prepared, for example, by mixing a positive electrode active material, carbon nanotubes, a polymer dispersant, a solvent, a positive electrode active material binding agent, and the like so as to achieve desired volume fractions and a dispersed state. Next, the solvent is mixed so as to provide a predetermined viscosity.

The negative electrode material paste is prepared, for example, by mixing a negative electrode active material, a solvent, a negative electrode active material binding agent, and the like so as to achieve desired volume fractions and a dispersion state.

The paste may be mixed while finely pulverizing objects into particles having a predetermined particle size so that the respective materials are further dispersed in the paste. For example, each material in the paste may be pulverized and mixed using a bead mill, a dispersion mill, or the like. Alternatively, each material in the paste may be pulverized and then mixed by ultrasonic dispersion or the like.

### Electrode Forming Step

The electrode material paste prepared in the paste preparation step is applied to both surfaces of the current collector so as to have a predetermined basis weight, and dried. For example, the electrode material paste may be applied onto the current collector using a die coater or the like.

Next, the electrode material formed on the current collector is pressed so as to have a predetermined porosity and then cut to provide a predetermined shape, thereby providing an electrode. For example, the electrode material may be pressed using a roll press machine or the like.

### Electrode Assembling Step

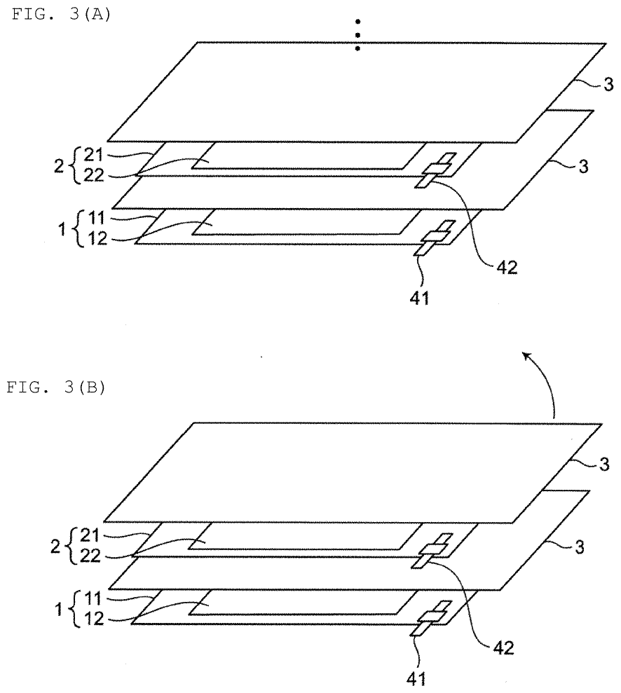

Although it is merely an example, in this step, for example, as shown in FIG. 2, the positive electrode 1, the negative electrode 2, and the separator 3 having a rectangular shape are arranged in a predetermined order and stacked or wound to provide a precursor of the electrode assembly. For example, as shown in FIG. 3A, the precursor of the electrode assembly may be a planar stacked electrode assembly 200 (see FIG. 1A) in which the positive electrode 1, the negative electrode 2, and the separator 3 are stacked in the thickness direction. Alternatively, as shown in FIG. 3B, the precursor of the electrode assembly may be a wound electrode assembly 200 (see FIG. 1B) obtained by winding the positive electrode 1, the negative electrode 2, and the separator 3 as indicated by the arrow. The assembling step of the wound electrode assembly will be described as a mere example.

First, a positive electrode 1 provided with a positive electrode current collector tab 41 attached to one side of a positive electrode current collector 11, a negative electrode 2 provided with a negative electrode current collector tab 42 attached to one side of a negative electrode current collector 21, and two separators 3 having a rectangular shape are arranged in a predetermined order and wound as indicated by the arrow (see FIG. 3B). By applying a predetermined tension to the separators 3 at the time of winding, the precursor or the wound body of the electrode assembly in which the separators 3 converge (or approach each other) toward a winding axis P toward the tips of the separators 3 in a separator extension portion is obtained. The tension applied to the separators 3 during winding is usually 0.1 N to 10 N, preferably 0.5 N to 3.0 N from the viewpoint of convergence.

The dimensions of the separators 3 that can be used are not particularly limited as long as a desired electrode assembly is obtained. For example, a length dimension w1 of the separators 3 in a width direction r is usually preferably 105% to 400%, and for example, 120% to 200%, with respect to the length of the positive electrode 1 or the negative electrode 2 in the winding axis direction (see FIG. 2). Further, for example, a length dimension w2 of the separators 3 in a longitudinal direction s may be appropriately determined according to the dimensions (particularly the number of windings of the electrode assembly) of the intended secondary battery.

After this step, the precursor of the wound electrode assembly may be formed into a substantially flat columnar shape by pressing the precursor in the diameter direction of the wound body as desired (see FIG. 1B).

### Housing Step

The electrode assembly obtained in the previous step is housed in the exterior body such that the current collector tabs of the positive electrode and the negative electrode extend from the exterior body (not illustrated), and the electrolyte is injected into the exterior body.

The secondary battery of the present invention and the method for manufacturing the same are not limited to the secondary battery illustrated above and the method for manufacturing the same of the embodiment of the present invention.

As will be described in detail in “Overall Rating” of examples described later, in the secondary battery according to the embodiment of the present invention, the dispersion time of carbon nanotubes in the electrode material paste is preferably 100 minutes or less, more preferably 85 minutes or less, and still more preferably 50 minutes or less. When the dispersion time is within the above range, the manufacturing process can be made efficient, such as shortening the dispersion time.

In the secondary battery according to the embodiment of the present invention, the solid content of the electrode material paste is preferably 70% or more, more preferably 72% or more, and still more preferably 75% or more. When the solid content is within the above range, drying efficiency in the manufacturing process can be improved.

In the secondary battery according to the embodiment of the present invention, the electrode volume resistivity is preferably 20 Ω·cm or less, more preferably 15 Ω·cm or less, and still more preferably 10 Ω·cm or less. When the electrode volume resistivity is within the above range, an electrode having a lower resistance can be provided. The “electrode volume resistivity” will be described in detail in the examples below.

In the secondary battery according to the embodiment of the present invention, the capacity retention rate is preferably 91% or more, more preferably 93% or more, and still more preferably 95% or more. When the capacity retention rate is within the above range, more excellent cycle characteristics can be exhibited. The “capacity retention rate” will be described in detail in the examples below.

In the secondary battery according to the embodiment of the present invention, the electrode volume resistivity is less than 21 Ω·cm, preferably 10 Ω·cm or less, and the capacity retention rate is more than 90%, preferably 95% or more. Within such a range, both lower resistance and cycle characteristics can be successfully exhibited.

### EXAMPLES

The present disclosure will be described below with reference to examples, but the present disclosure is not limited by these examples.

### Example 1

An electrode and a secondary battery using the electrode were produced on the basis of a manufacturing method described below.

### Positive Electrode

### Formation Procedure

(1) Carbon nanotubes were added to N-methylpyrrolidone (NMP) in which an acrylic polymer 1 having a molecular weight of 40,000 g/mol had been dissolved. Here, the weight ratio of the acrylic polymer 1 to the carbon nanotubes was 0.10. The carbon nanotubes had a basic site amount and an acid site amount of 0.10 μmol/m² and 0.03 μmol/m², respectively.

(2) Using a bead mill, carbon nanotubes were dispersed until the D50 of the carbon nanotubes became 5 μm or less. The required dispersion time was 90 min.

(3) Polyvinylidene fluoride and lithium cobaltate were added to the mixture prepared in Step (2) using a dispersion mill to disperse lithium cobaltate. Next, NMP was mixed and dispersed so that the viscosity at 60 rpm measured with a Brookfield viscometer was 5 Pa·s, thereby providing a positive electrode material paste. The solid content of the positive electrode material paste was 70%.

(4) Using a die coater, the positive electrode material paste was applied onto both surfaces of an aluminum foil having a thickness of 12 μm so that the basis weight of one surface was 18.9 mg/cm², and dried.

(5) Compaction was performed using a roll press machine so that the porosity became 16%.

(6) A positive electrode was obtained by cutting into a predetermined shape.

### Negative Electrode

### Formation Procedure

(1) Artificial graphite, flake graphite, carboxymethyl cellulose (CMC), and styrene butadiene rubber (SBR) were mixed while being dispersed in water to provide a negative electrode material paste.

(2) Using a die coater, the negative electrode material paste was applied onto both surfaces of a copper foil having a thickness of 10 μm so that the basis weight of one surface was 10.0 mg/cm², and dried.

(3) Compaction was performed using a roll press machine so that the porosity became 25%.

(4) A negative electrode was obtained by cutting into a predetermined shape.

### Secondary Battery

### Production Procedure

(1) A plurality of positive electrodes and a plurality of negative electrodes were alternately stacked with separators interposed therebetween, the positive electrodes and the negative electrodes were each bundled and subjected to tab welding, and the product was then housed in an aluminum laminated cup.

(2) An electrolytic solution (1M LiPF₆, ethylene carbonate (EC):ethyl methyl carbonate (EMC)=25:75 vol) was injected into the aluminum laminated cup, and then the aluminum laminate cup was temporarily vacuum-sealed. Subsequently, a secondary battery (capacity: 2 Ah) was produced by performing charging and discharging at 0.2 CA and then performing full vacuum sealing.

(3) The resulting secondary battery was charged to SOC 70% and subjected to aging treatment at 55° C. for 24 hours.

### Example 2

Evaluation samples (that is, a positive electrode and a secondary battery) were obtained in a similar manner to that in Example 1 except that the weight ratio of the acrylic polymer 1 to the carbon nanotubes was 0.20. Here, the required dispersion time of the carbon nanotubes was 55 min, and the solid content in the positive electrode material paste was 73%.

### Example 3

Evaluation samples were obtained in a similar manner to that in Example 1 except that the weight ratio of the acrylic polymer 1 to the carbon nanotubes was 0.30. Here, the required dispersion time of the carbon nanotubes was 50 min, and the solid content in the positive electrode material paste was 75%.

### Example 4

Evaluation samples were obtained in a similar manner to that in Example 1 except that an acrylic polymer 2 having a molecular weight of 600,000 g/mol was used. Here, the required dispersion time of the carbon nanotubes was 95 min, and the solid content in the positive electrode material paste was 71%.

### Example 5

Evaluation samples were obtained in a similar manner to that in Example 4 except that the weight ratio of the acrylic polymer 2 to the carbon nanotubes was 0.20. Here, the required dispersion time of the carbon nanotubes was 65 min, and the solid content in the positive electrode material paste was 74%.

### Example 6

Evaluation samples were obtained in a similar manner to that in Example 4 except that the weight ratio of the acrylic polymer 2 to the carbon nanotubes was 0.30. Here, the required dispersion time of the carbon nanotubes was 55 min, and the solid content in the positive electrode material paste was 75%.

### Example 7

Evaluation samples were obtained in a similar manner to that in Example 1 except that except that the acrylic polymer 1 and the acrylic polymer 2 were mixed at a mixing ratio of 1:1. Here, the required dispersion time of the carbon nanotubes was 85 min, and the solid content in the positive electrode material paste was 72%.

### Example 8

Evaluation samples were obtained in a similar manner to that in Example 7 except that the total weight ratio of the acrylic polymer 1 and the acrylic polymer 2 to the carbon nanotubes was 0.20. Here, the required dispersion time of the carbon nanotubes was 50 min, and the solid content in the positive electrode material paste was 75%.

### Example 9

Evaluation samples were obtained in a similar manner to that in Example 7 except that the total weight ratio of the acrylic polymer 1 and the acrylic polymer 2 to the carbon nanotubes was 0.30. Here, the required dispersion time of the carbon nanotubes was 50 min, and the solid content in the positive electrode material paste was 75%.

### Comparative Example 1

Evaluation samples were obtained in a similar manner to that in Example 1 except that polyvinylpyrrolidone having a molecular weight of 360,000 g/mol was used. Here, the required dispersion time of the carbon nanotubes was 135 min, and the solid content in the positive electrode material paste was 69%.

### Comparative Example 2

Evaluation samples were obtained in a similar manner to that in Comparative Example 1 except that the weight ratio of polyvinylpyrrolidone to the carbon nanotubes was 0.30. Here, the required dispersion time of the carbon nanotubes was 60 min, and the solid content in the positive electrode material paste was 72%.

The battery performance (electrode volume resistivity and capacity retention rate after 300 cycles) of each sample in the above-described examples and comparative examples was evaluated. Details of each evaluation method will be described below.

### Electrode Volume Resistivity

Each of the positive electrode material pastes in the examples and comparative examples was applied onto a PET film using an applicator with a gap of 200 μm and dried in an oven at 120° C., and then the electrode volume resistivity was measured by four-terminal sensing using a volume resistivity meter (manufactured by Mitsubishi Chemical Corporation/model number: Loresta).

### Capacity Retention Rate after 300 Cycles

For each secondary battery in the examples and comparative examples after aging, the capacity retention rate after repeating the charge and discharge cycle 300 times was measured. Specifically, on the basis of the following “1 cycle”, the capacity retention rate after 300 cycles on the premise that charging (“constant-current constant-voltage charging”) and discharging were repeated in a thermostatic bath environment at 35° C. was measured. Here, the capacity retention rate is calculated by Formula (3) below.

$$Capacity retention rate ( \% ) = ( discharge capacity at 300 th cycle / discharge capacity at first cycle ) \times 100 \qquad Equation 3$$

### One Cycle

For the resulting secondary battery, a combination of charging in which constant current charging is performed up to a voltage of 4.35 V at a current value of 1 C and then constant voltage charging is performed at a voltage of 4.35 V for 1 hour and discharging in which constant current discharging is performed up to a voltage of 3.00 V at a current value of 1 C after taking a pause time of 10 minutes after the charging is defined as 1 cycle (note that a rest time of 10 minutes is taken between cycles).

### Overall Rating

Each sample in the examples and comparative examples was comprehensively evaluated according to the following criteria.

S: All the requirements that the dispersion time of carbon nanotubes is 50 min or less, the solid content of the electrode material paste is 75% or more, the electrode volume resistivity is 10 Ω·cm or less, and the capacity retention rate of the secondary battery is 95% or more are satisfied.

A: All the requirements that the dispersion time of carbon nanotubes is 85 min or less, the solid content of the electrode material paste is 72% or more, the electrode volume resistivity is 15 Ω·cm or less, and the capacity retention rate of the secondary battery is 93% or more are satisfied.

B: All the requirements that the dispersion time of carbon nanotubes is 100 min or less, the solid content of the electrode material paste is 70% or more, the electrode volume resistivity is 20 Ω·cm or less, and the capacity retention rate of the secondary battery is 91% or more are satisfied.

C: None of S, A, or B is applicable.

Details and evaluation results of each sample in the examples and comparative examples are shown in Table 1.

TABLE 1

| | | | | | | Electrode | Capacity | |
|---|---|---|---|---|---|---|---|---|
| | | | Weight ratio | Dispersion | Solid content | (positive | retention | |
| | | Molecular | of dispersant | time of | of positive | electrode) | rate of the | |
| | | weight of | to carbon | carbon | electrode | volume | secondary | |
| | | dispersant | nanotubes | nanotubes | material paste | resistivity | battery | Overall |
| | Type of dispersant | (10,000 g/mol) | (—) | (min) | (%) | (Ω · cm) | (%) | rating |
| Example 1 | Acrylic polymer 1 | 4 | 0.10 | 90 | 70 | 16 | 91 | B |
| Example 2 | Acrylic polymer 1 | 4 | 0.20 | 55 | 73 | 9 | 95 | A |
| Example 3 | Acrylic polymer 1 | 4 | 0.30 | 50 | 75 | 6 | 94 | A |
| Example 4 | Acrylic polymer 2 | 60 | 0.10 | 95 | 71 | 15 | 92 | B |
| Example 5 | Acrylic polymer 2 | 60 | 0.20 | 65 | 74 | 9 | 95 | A |
| Example 6 | Acrylic polymer 2 | 60 | 0.30 | 55 | 75 | 5 | 94 | A |
| Example 7 | Acrylic polymer 1 | 4 | 0.05 | 85 | 72 | 12 | 95 | A |
| | Acrylic polymer 2 | 60 | 0.05 | | | | | |
| Example 8 | Acrylic polymer 1 | 4 | 0.10 | 50 | 75 | 8 | 97 | S |
| | Acrylic polymer 2 | 60 | 0.10 | | | | | |
| Example 9 | Acrylic polymer 1 | 4 | 0.15 | 50 | 75 | 4 | 96 | S |
| | Acrylic polymer 2 | 60 | 0.15 | | | | | |
| Comparative | Polyvinylpyrrolidone | 36 | 0.10 | 135 | 69 | 21 | 86 | C |
| Example 1 | | | | | | | | |
| Comparative | Polyvinylpyrrolidone | 36 | 0.30 | 60 | 72 | 9 | 90 | C |
| Example 2 | | | | | | | | |

As shown in Table 1, it was found that all of the samples in Examples 1 to 9 each had an electrode volume resistivity of 20 or less and a capacity retention rate after 300 cycles of 91% or more (B or higher overall rating) and exhibited higher battery performance than that of the samples in the comparative examples.

In addition, comparisons between samples having the same weight ratio of polymer dispersants to carbon nanotubes showed that each sample in the examples exhibited a shorter dispersion time of carbon nanotubes than each sample in the comparative examples. Further, it was confirmed that the solid content of the electrode material paste can be increased and that the drying efficiency can be improved.

Although the embodiment of the present invention have been described above, only typical examples have been illustrated. A person skilled in the art can easily understand that the present invention is not limited thereto and that various modes are conceivable without changing the gist of the present invention.

The secondary battery according to the embodiment of the present invention can be used in various fields where storage of electricity is assumed. Although it is merely an example, the secondary battery can be used in the fields of electricity, information, and communication in which electricity, electronic equipment, and the like are used (such as the field of electric/electronic devices or the field of mobile devices including mobile phones, smartphones, notebook computers and digital cameras, activity trackers, arm computers, electronic paper, wearable devices, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, electric two-wheeled vehicles, and the like), power system applications (such as the fields of various types of power generation, road conditioners, smart grids, and home energy storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

1: Positive electrode

11: Positive electrode current collector

12: Positive electrode material layer

2: Negative electrode

21: Negative electrode current collector

22: Negative electrode material layer

3: Separator

4: Current collector tab

41: Positive electrode current collector tab

42: Negative electrode current collector tab

43: Insulating material

100: Electrode constituent unit

200: Electrode assembly

1. A secondary battery comprising:
a positive electrode;
a negative electrode; and
a separator between the positive electrode and the negative electrode,
wherein at least one of the positive electrode and the negative electrode contains an electrode active material, a carbon nanotube, and a polymer dispersant,
the carbon nanotube has a basic site amount relatively larger than an acid site amount, and
the polymer dispersant has an acidic functional group.

2. The secondary battery according to claim 1, wherein the acidic functional group is a carboxy group.

3. The secondary battery according to claim 1, wherein the electrode active material is basic or has a basic functional group.

4. The secondary battery according to claim 1, wherein a weight ratio of the polymer dispersant to the carbon nanotube in the electrode is 0.1 to 0.8.

5. The secondary battery according to claim 1, wherein a weight ratio of the polymer dispersant to the carbon nanotube in the electrode is 0.1 to 0.5.

6. The secondary battery according to claim 1, wherein a weight ratio of the polymer dispersant to the carbon nanotube in the electrode is 0.2 to 0.3.

7. The secondary battery according to claim 1, wherein the polymer dispersant contains a polymer having a weight average molecular weight of 10,000 g/mol to 1,000,000 g/mol.

8. The secondary battery according to claim 1, wherein the polymer dispersant contains both a relatively low molecular weight dispersant having a weight average molecular weight of less than 50,000 g/mol and a relatively high molecular weight dispersant having a weight average molecular weight of 50,000 g/mol.

9. The secondary battery according to claim 1, wherein the polymer dispersant contains a polycarboxylic acid.

10. The secondary battery according to claim 1, wherein the polymer dispersant contains an acrylic polymer.

11. The secondary battery according to claim 1, wherein the carbon nanotube has a BET specific surface area of 100 m²/g or more.

12. The secondary battery according to claim 1, wherein the carbon nanotube has a BET specific surface area of 150 m²/g to 3,000 m²/g.

13. The secondary battery according to claim 1, wherein the carbon nanotube has a BET specific surface area of 200 m²/g to 1,500 m²/g.

14. The secondary battery according to claim 1, wherein the electrode has an electrode volume resistivity of less than 21 Ω·cm.

15. The secondary battery according to claim 1, wherein a capacity retention rate of the secondary battery is more than 90%.

16. The secondary battery according to claim 1, wherein the positive electrode contains the electrode active material, the carbon nanotube, and the polymer dispersant.

17. The secondary battery according to claim 1, wherein the negative electrode contains graphite.

18. The secondary battery according to claim 1, wherein the secondary battery is constructed as a nonaqueous electrolyte secondary battery in which the positive electrode and the negative electrode occlude and release ions through a nonaqueous electrolyte.

19. The secondary battery according to claim 1, wherein the positive electrode and the negative electrode are constructed to occlude and release lithium ions.
